(19) United States
(12) Patent Application Publication
(10) Pub. No.: US 2016/0109039 A1
(43) Pub. Date: Apr. 21, 2016

(54) TUBE AND LOCKING CAP ASSEMBLY FOR AXIALLY ALIGNING AND SUPPORTING ELONGATE MEMBERS

(71) Applicant: Donald T. Munsch, Santa Rosa, CA (US)

(72) Inventor: Donald T. Munsch, Santa Rosa, CA (US)

(21) Appl. No.: 14/520,268

(22) Filed: Oct. 21, 2014

(51) Int. Cl. F16L 7/00

(52) U.S. Cl. CPC F16L 7/00

(57) ABSTRACT

A tube and fitting assembly for axially aligning and supporting elongate members, that includes a support and centering tube having a first end, a second end, a longitudinal passage running the entire length of the support and centering tube for passing a portion of the elongate member, and coupling structure on or proximate each of the first and second ends; a removable bar for placement in the longitudinal passage so as to form an enclosure with open ends; a locking cap assembly including first and second slotted inner locking caps each having a side slot for passing a small segment of the elongate member and coupling features for connecting to the coupling structure on the first and second ends, respectively, of the support and centering tube; and first and second slotted outer locking caps, each having coupling features for coupling to the first and second locking caps.

### CROSS REFERENCES TO RELATED APPLICATIONS

Not applicable. The present application is an original and first-filed United States Utility Patent Application.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

Field of the Invention: The present invention relates most generally to supports for elongate members, such as ropes, cables, wires, cords, and the like, and more specifically to means for rigidifying and supporting cords, cables, wires, ropes, and unsupported elongate articles, and still more particularly to a support tube and locking collar assembly for axially aligning and supporting elongate members.

### BRIEF SUMMARY OF THE INVENTION

The present invention is a support tube and locking cap assembly for supporting and centering flexible elongate members.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1A is an upper front end perspective view of the locking cap system of the present invention showing a flexible elongate member (e.g., a cord) poised for insertion into the support tube;

FIG. 1B is the same view showing the flexible elongate member insert into the support tube and the locking cap combination applied to a first end;

FIG. 2A is an exploded cross-section side view in elevation showing a first or second end of the support and centering tube and its corresponding locking cap combination, as taken along section line 2A-2A in FIG. 1B.

FIG. 2B is the same view with the locking cap components assembled

FIG. 3A is an exploded upper perspective view showing a second preferred embodiment of the inventive tube and locking cap assembly;

FIG. 3B is the same view showing the apparatus assembled with an inner locking cap installed over the support and centering tube;

FIG. 4A is an exploded cross-sectional side view in elevation showing one end of the support and centering tube with first and second locking caps positioned for sequential installation; and

FIG. 4B is the same view showing the locking caps installed.

### DETAILED DESCRIPTION OF THE INVENTION

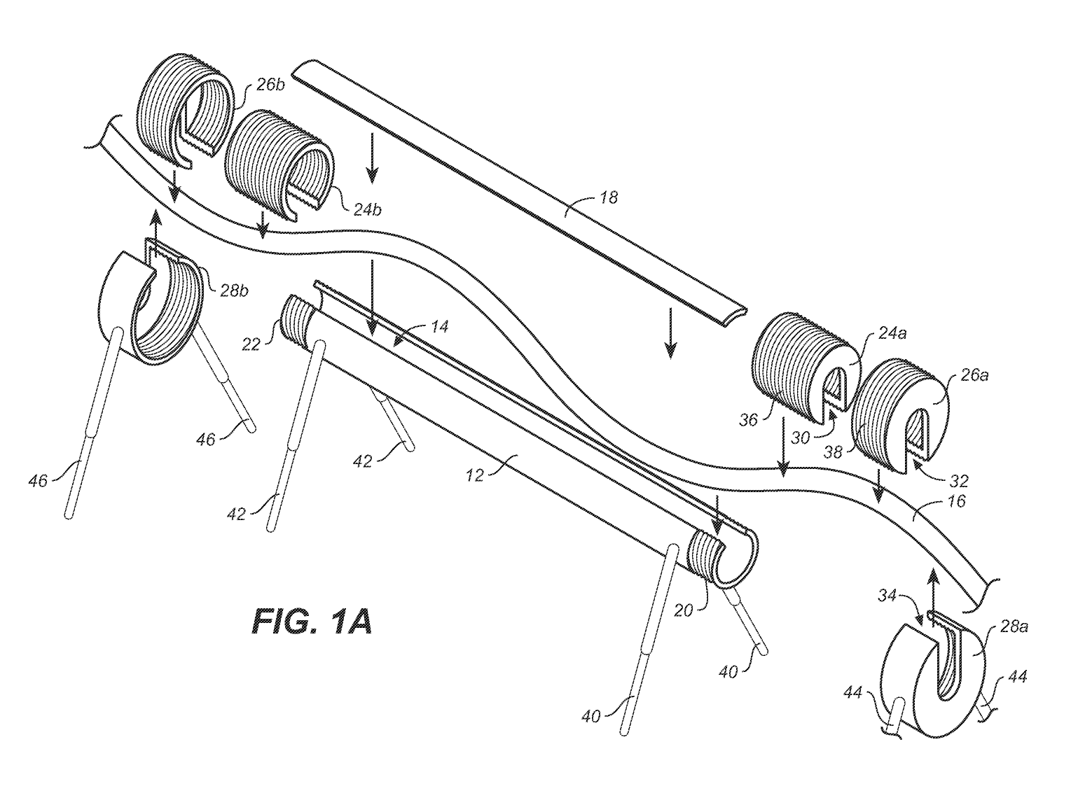

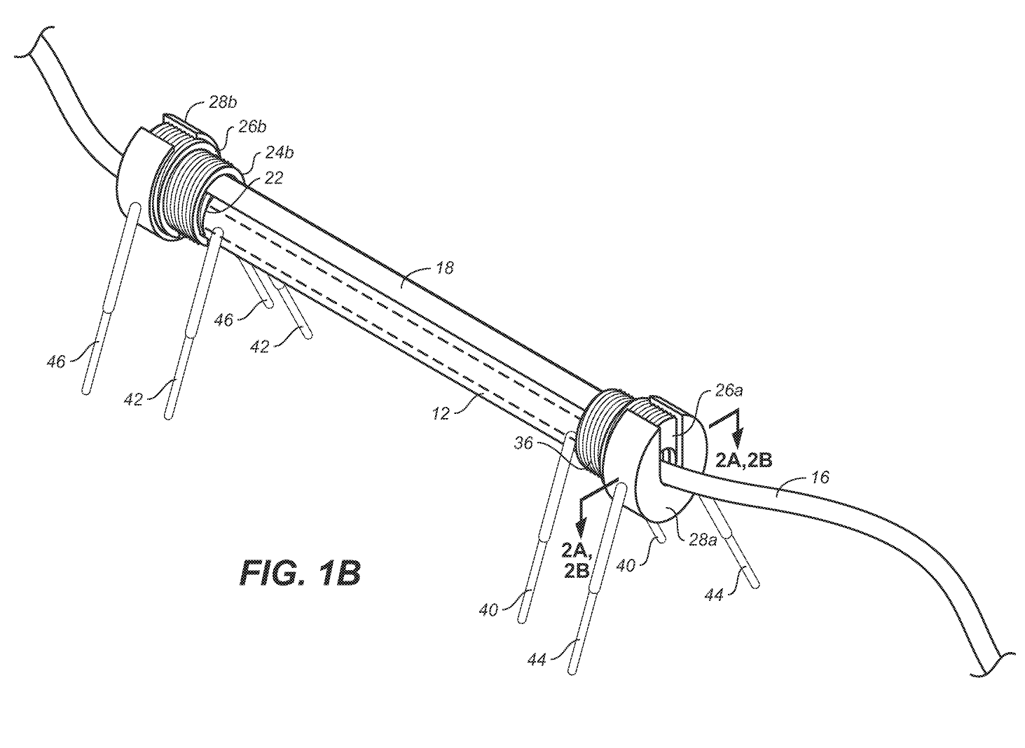

Referring to FIGS. 1A through 4B, wherein like reference numerals refer to like components in the various views, there is illustrated therein a tube and locking cap assembly for aligning and supporting flexible elongate members, generally denominated 10 herein.

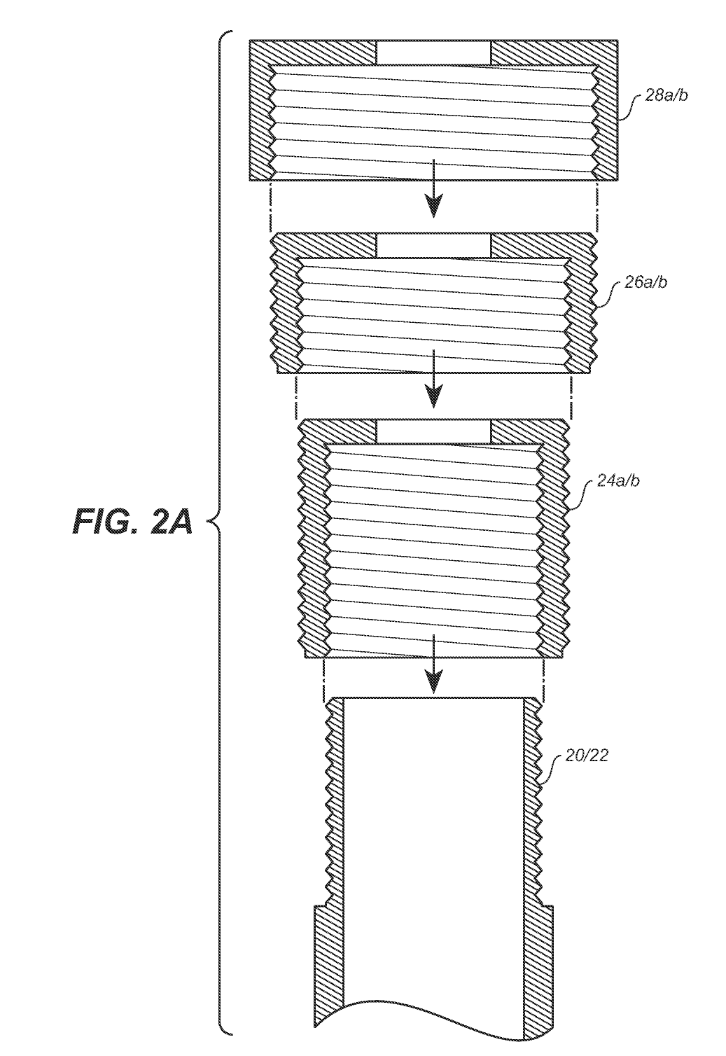

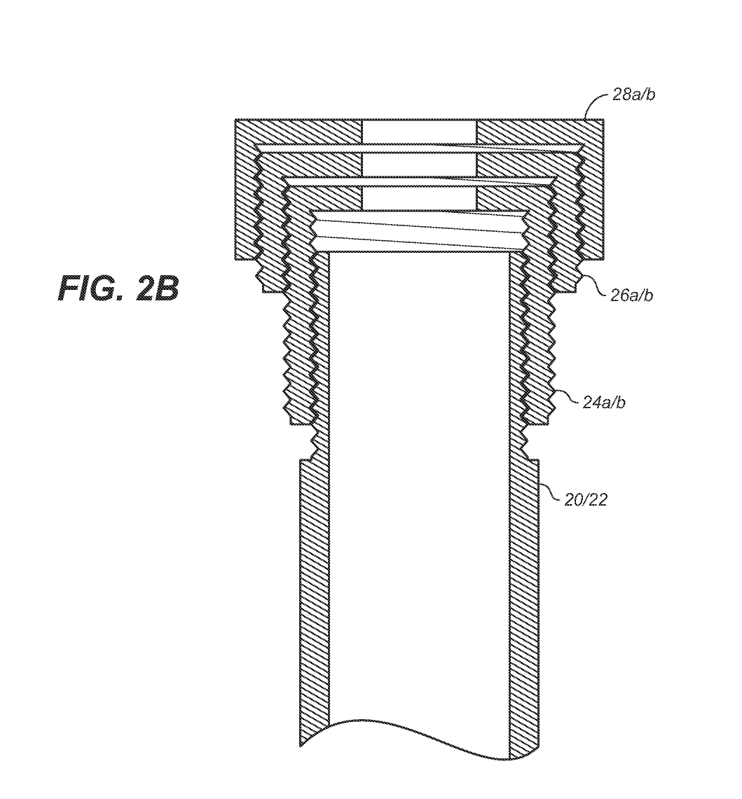

Referring first to FIGS. 1A-2B, these view show collectively that in a first preferred embodiment of the inventive apparatus there is included a slotted cylindrical support and centering tube 12 (“support tube”) having a full length longitudinally oriented slot 14 sized to accommodate flexible elongate member 16 of a size up to but less than the diameter of the support and centering tube 12. An arcuate slat or bar 18 (a tube portion comprising essentially the piece cut from the support tube to form the slot 14) fits onto and covers the slot so as to complete the open ended enclosure provided by the support and centering tube. Preferably the support and centering tube 12 is entirely cylindrical, though only the ends must be cylindrical for an embodiment employing threaded locking caps (referred to variously herein as “locking caps” and/or “locking collars”), inasmuch as they include first and second threaded ends 20, 22 that each accept slotted and threaded locking collars that are screwed onto the ends.

In a first preferred embodiment, the locking cap set includes an annular inner locking cap 24a, 24b, an annular medial locking cap 26a, 26b, and an annular outer locking cap 28a, 28b, each having a side slot 30a/30b, 32a/32b, 34a/34b, respectively, which accept and allow to pass a small segment of the elongate member disposed in the support and centering tube 12.

Once the elongate member is inserted into the support tube, the inner locking cap 24a 24b, are placed over the elongate member and then threadably screwed onto the first and second ends 20, 22 of the support and centering tube 12. The inner locking caps 24a, 24b, include a threaded exterior 36a, 36b, onto which a medial locking cap 26a, 26b, can be threadably coupled. The medial locking caps, in turn, also have a threaded exterior surface 38a, 38b, onto which an outer locking cap 28a, 28b, can be threadably coupled. The slots 30a/b, 32a/b, 34a/b can be aligned differentially (i.e., misaligned relative to one another and to the support tube slot 14) so as to provide full circumferential support for the elongate member. In so doing, it provides the centering and alignment at both ends in whatever configuration and orientation is desired—horizontal, vertical, etc.

As will be appreciated, the support and centering tube can be round, square, or any cross-sectional shape, and it can even have a twist in it, as long as it has cylindrical ends for the locking collar installation. The centering tube may also have varying cross-sectional shapes or diameters anywhere along its length, as long as the locking collars meet the specifications required at each end.

Further, as will also be appreciated, the side slots in each of the locking caps individually form an opening smaller than the opening at the ends of the support and centering tube, such that as the locking caps are installed in order, the opening becomes increasingly smaller, thereby capturing and restraining movement in the elongate member.

The support and centering tube 12 need not be rigid material; it can be a cable. The elongate member can be a reciprocating device, a rotating device, or both, such as in a hammer drill or a plumbing snake. In such a case, the locking caps can be configured to accomplish a rigid and sturdy connection and lubrication can be provided as needed.

To use the inventive apparatus, an elongate member is inserted in the longitudinal slot 14 of the support and centering tube 12, the slot having a slightly larger diameter than the elongate member, cable, or etc., the slot running the length of the support and centering tube. The arcuate slat or bar 18 is then placed into the slot 14, thus joined with the slotted support and centering tube to form an enclosure around the elongate member, but still having open ends. Then, on the first end 20 of the support and centering tube, a first inner slotted locking cap 24a is installed, and this controls 180 degrees of the elongate member, keeping it secured within the slot in that particular collar. Next, a second inner locking cap 24b is installed on the opposite threaded end 22 of the support and centering tube, and the slot on that collar is also oriented 180 opposite the slot 14 of the support and centering tube 12. Next, first and second medial locking caps 26a, 26b are installed on each end and misaligned relative to the first and second inner locking caps 26a, 26b on their respective ends of the support and centering tube. This controls the other 180 degrees of movement, inasmuch as the slots—30a relative to 32b, and 30b relative to 32b—are both opposed and misaligned. This may be sufficient to complete the centering and alignment process. However, if it is desired to have even further stability, an outer locking cap 28a, 28b can be threadably installed onto the medial locking cap at each end, and their respective slots 34a/34b misaligned in any direction relative to the slots 32a/32b in the medial locking caps, though preferably they are oriented approximately 90 degrees relative to those slots.

With this assembly it is possible to have long runs of cable that can be rapidly contained and controlled anywhere along its length by three threaded slotted members installed from the side. Applications include controlling cables to align them with pulleys or for aligning shafts to machinery for connection and operation.

The addition of adjustable legs 40, 42 at approximately the 4 and 8 o'clock positions on the lower portion of the slotted support and centering tube 12 and another set 44 on the outer locking collar 28 help to rapidly identify and control slot orientation, thus cable (elongate member) control.

As suggested above, it will be appreciated that a number of suitable cross-sectional shapes are possible for use for the support and centering tube, and there are correspondingly multiple ways of coupling the three locking collars, not limited to the use of threads. Rather, locking can be accomplished using tabs in slots that slip on and rotate to indents, or ball plungers that snap together, or opposing clips that engage grooves. Such a structure would be well suited to a square support and centering tube. Further, the slotted support and centering tube may contain bearings to slotted bulkheads on its interior, and rotation control, reciprocation control, and lubrication and/or evacuation could be accomplished. Outer and inner fittings can be provided as needed for the particular kind of elongate member sought to be supported and aligned.

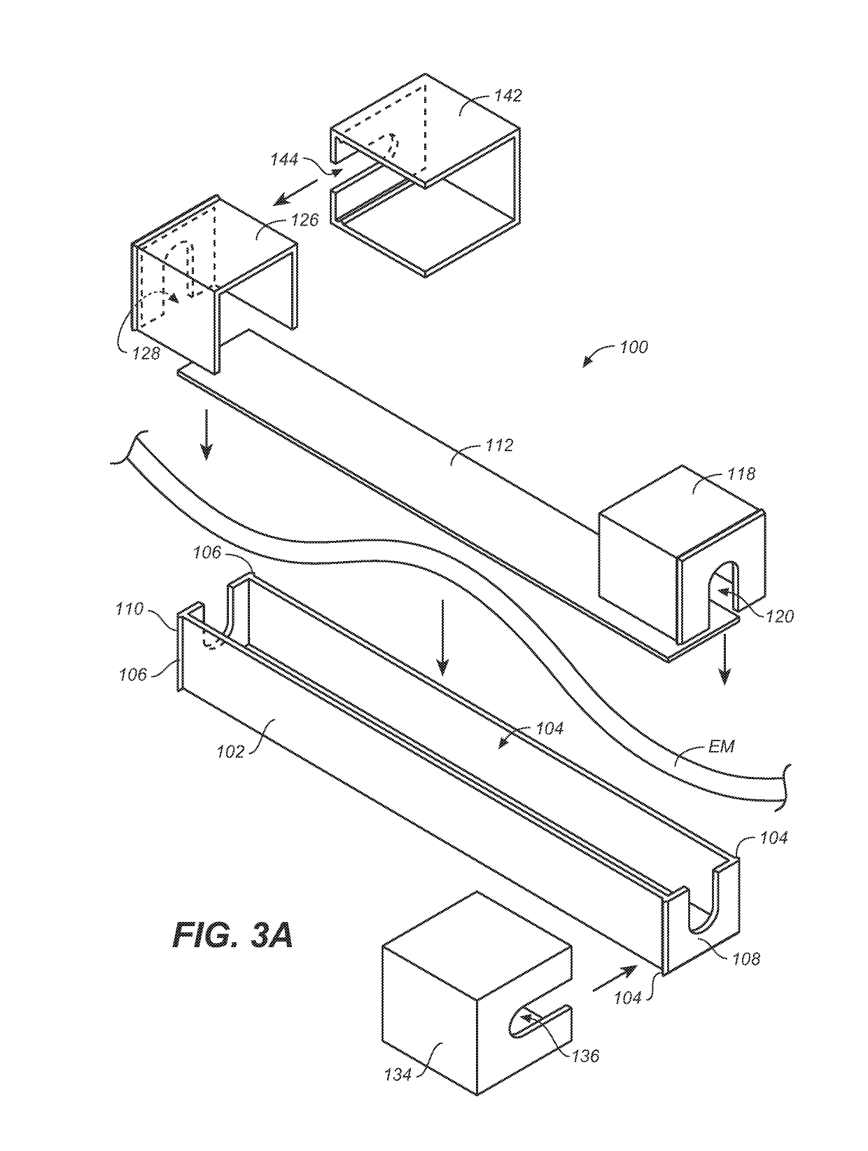

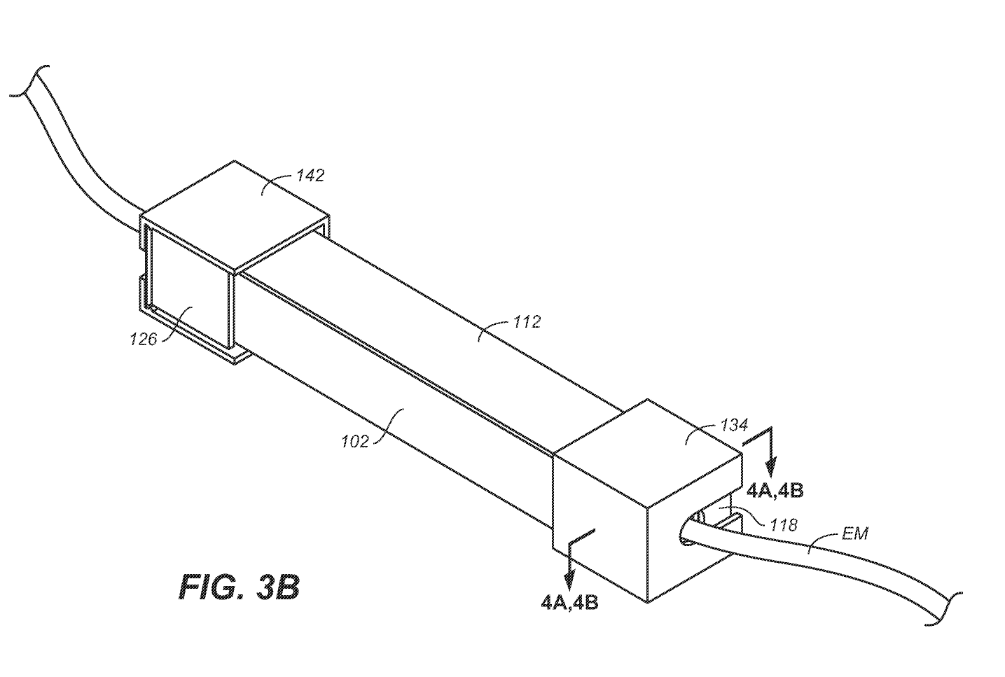

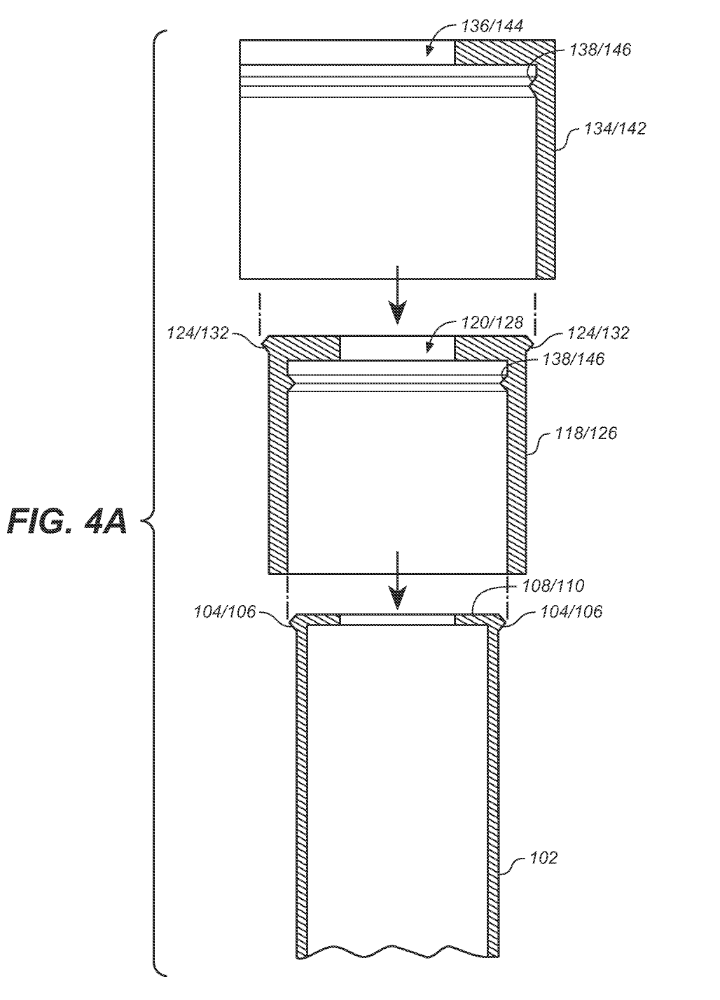

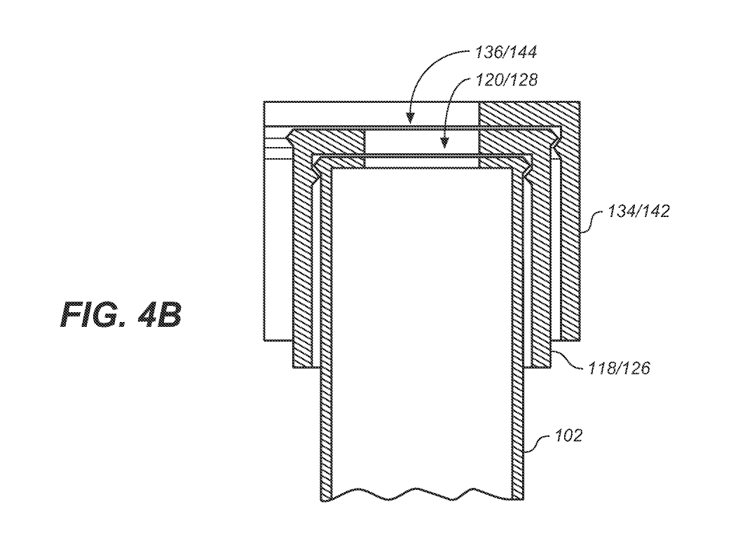

FIGS. 3A-4B show such an alternative preferred embodiment 100. In this embodiment, the support and centering tube 102 is square in cross section and includes coupling ridges 104, 106, on at least two (and preferably three) sides of the tube proximate each of its first and second ends, 108, 110, respectively. As with the first preferred embodiment, this design includes a removable slat or bar 112 that forms a portion of the completed support and centering tube, and when removed provides a longitudinal slot or open side 114 running the entire length of the support and centering tube and through which an elongate member 116 may be passed anywhere along the length of the elongate member (rather than having to insert the end of the elongate member through an open end of the support tube). Additionally, and as with the first preferred embodiment, once the removable bar is placed in the slot, it forms a complete enclosure surrounding the elongate member, but having open ends. It is the locking collar/cap assembly placed over the open ends that completes the fundamental purpose of the present invention, viz., support, centering, and alignment of the elongate member.

After the elongate member is placed in the centering tube, a first slotted inner locking cap 118 is provided, which includes a slot 120, circumferential or parallel interior ridge elements 122, disposed on the interior sides of the cap parallel to the slot, and coupling ridges 124 disposed on the exterior side of the cap. This first slotted inner locking cap 118 is installed on the first end 108 such that the interior ridge elements 122 engage and the coupling ridge 104 on the first end 108 of the support and centering tube 102.

A second slotted inner locking cap 126 is provided for the second end, and includes a slot 128, circumferential or parallel interior ridge elements 130, disposed on the interior sides of the cap parallel to the slot 128, and coupling ridges 132 disposed on the exterior side of the cap. This second slotted inner locking cap 126 is installed on the second end 110 such that the interior ridge elements 130 engage the coupling ridge 106 on the second end 110 of the support and centering tube 102.

The sides of the first and second inner locking caps are slightly flexible, such that coupling with the support and centering tube is at least partially in the manner of a snap-fit connection, and removal simply entails the application of sufficient sideways force to slide the caps off the support and centering tube. The slots 120/128 may be oriented in the same direction as one another or may be misaligned to open in different directions at their respective ends, but both are oriented is such a way as to be misaligned with the longitudinal slot (or open side) of the support and centering tube. Accordingly, because the slots in the caps are smaller than the openings in the support and centering tube, this provides a first centering configuration to partially confine movement of the elongate member within the tube opening by providing an opening of slightly reduced size.

Next, a first slotted outer cap 134 having a slot 136, and one or more interior ridge elements 138, is installed on the first end 108 so as to engage the coupling groove 124 on the first slotted inner locking cap 118; and a second slotted outer cap 142 having a slot 144, and one or more interior ridge elements 146, is installed on the second end 110 so as to engage the coupling ridges 132 on the second slotted inner locking cap 126. The slots on the first and second slotted outer locking caps are oriented 90 degrees relative to the slots on the slotted inner locking caps. This provides the second centering configuration.

As with the first preferred embodiment, a medial locking cap can be provided, if desired, the medial locking caps having structure essentially identical to the inner locking caps, and sizing adapted for positioning between the inner and outer caps. This provides a third and final centering configuration, and the three-cap combination ensures that an elongate member EM, such as a cord or wire, is securely retained and axially aligned in the center of the support and centering tube. As will be appreciated, the square cross-section caps in this embodiment are functionally equivalent to the annular locking caps of the first preferred embodiment and may be regarded as such, i.e., locking collars or caps of the same essential kind and directed to achieving the same useful purpose.

From the foregoing, it will be seen that in its most essential aspect, the inventive tube and locking collar assembly includes a support and centering tube having a first end, a second end, a longitudinal passage running the entire length of the support and centering tube for passing a portion of the elongate member, and coupling structure on or proximate each of the first and second ends; a removable bar for placement in the longitudinal passage so as to form an enclosure with open ends; a locking cap assembly including first and second slotted inner locking caps each having a side slot for passing a small segment of the elongate member and coupling features for connecting to the coupling structure on the first and second ends, respectively, of the support and centering tube; and first and second slotted outer locking caps, each having coupling features for coupling to the first and second locking caps.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

For instance, it would be obvious to one with skill to reverse the groove and ridge configuration of the tube and locking caps of the second preferred embodiment, such that the support and centering tube includes ridges proximate its ends and the locking caps include circumferential grooves at least on the interior sides parallel to the slots. Such changes are incidental, contemplated by the disclosure, and included within the scope of the claims.

Therefore, the above description and illustrations should not be construed as limiting the scope of the invention, which is defined by the appended claims.

What is claimed as invention is:

1. A tube and fitting assembly for axially aligning and supporting elongate members, comprising:
a support and centering tube having a first end, a second end, a longitudinal passage running the entire length of said support and centering tube for passing a portion of the elongate member, and coupling structure on or proximate each of said first and second ends;
a removable bar for placement in said longitudinal passage so as to form an enclosure with open ends;
a locking cap assembly including first and second slotted inner locking caps each having a side slot for passing a small segment of said elongate member and coupling features for connecting to the coupling structure on said first and second ends, respectively, of said support and centering tube; and
first and second slotted outer locking caps, each having coupling features for coupling to said first and second locking caps;
wherein placement of said first and second slotted inner locking caps such that the side slots of each are oriented differently to constrict and the elongate element and reduce its movement within the opening at the ends of said support and centering tube.

2. The tube and fitting assembly of claim 1, wherein said support and centering tube is cylindrical at least at its end portions, and said coupling structure on said support and centering tube comprises threads.

3. The tube and fitting assembly of claim 2, wherein said coupling features on said locking collars comprise threads complementary to said threads on said support and centering tube.

4. The tube and fitting assembly of claim 3, wherein said support and centering tube is cylindrical.

5. The tube and fitting assembly of claim 1, wherein said support and centering tube is cylindrical.

6. The tube and fitting assembly of claim 1, wherein said coupling apparatus on said support and centering tube comprises a coupling ridge disposed proximate each of said first and second ends.

7. The tube and fitting assembly of claim 6, wherein said coupling apparatus on said slotted inner locking caps comprises interior ridge elements.

8. The tube and fitting assembly of claim 7, wherein said support and centering tube is square in cross section.

9. The tube and fitting assembly of claim 1, wherein said support and centering tube is square in cross section.

10. The tube and fitting assembly of claim 9, wherein, said coupling apparatus on said support and centering tube comprises a coupling ridge disposed proximate each of said first and second ends.

11. The tube and fitting assembly of claim 10, wherein said coupling apparatus on said slotted inner locking caps comprises interior ridge elements.

12. The tube and fitting assembly of claim 11, wherein said slotted inner locking caps include exterior coupling ridges to engage coupling apparatus of an outer locking cap.

13. The tube and fitting assembly of claim 12, wherein said coupling apparatus on said slotted outer locking caps comprises interior ridge elements.

14. A slotted support and centering tube and locking cap combination for installation over a medial segment of an elongate member, comprising:
a support and centering tube having first and second ends and a longitudinal slot extending to and through each of said first and second ends and sized for insertion and passage of the elongate member;
a panel installable over the slot in said support and centering tube so as to provide an enclosed tube having open ends; and
first and second locking cap sets, one each fitted for installation over each of said first and second ends, each of said locking cap sets including an inner locking cap for placement around the elongate member and directly over an end of said support and centering tube, and having a slot defining an opening smaller than the opening in said support and centering tube, and an outer locking cap inner for placement around the elongate member and directly over an inner locking cap, said outer locking caps having a slot defining an opening smaller than the opening in said support and centering tube.
